(19) United States
(12) Patent Application Publication
(10) Pub. No.: US 2026/0058420 A1
(43) Pub. Date: Feb. 26, 2026

(54) CONNECTOR HOUSING ASSEMBLY AND COAXIAL CONNECTOR

(71) Applicants: Tyco Electronics (Shanghai) Co., Ltd., Shanghai (CN); Tyco Electronics Technology (SIP) Co., Ltd., Suzhou (CN)

(72) Inventors: Ling Liu, Suzhou (CN); Jianjia Qi, Shanghai (CN); Feng (Carlos) Pan, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/304,051

(22) Filed: Aug. 19, 2025

(30) Foreign Application Priority Data
Aug. 20, 2024 (CN) 202411149018.8

(51) Int. Cl. H01R 13/73; H01R 24/38

(52) U.S. Cl. CPC H01R 13/73; H01R 24/38

(57) ABSTRACT

A connector housing assembly includes a rear cover comprising an outer peripheral wall and a rear end wall that enclose an accommodating chamber. The connector housing assembly further includes a housing. The housing includes an outer cylinder, a flange portion formed on an outer side of a rear end portion of the outer cylinder, and an inner cylinder portion located in the outer cylinder and connected to an inner side of the outer cylinder, the housing is a one-piece metal part, the flange portion of the housing is fixed to an outer side of the rear end wall of the rear cover, and the inner cylinder portion of the housing serves as an outer terminal of a coaxial connector.

### CROSS-REFERENCE TO RELATED APPLICATIONS

This application claims the benefit of Chinese Patent Application No. CN202411149018.8 filed on Aug. 20, 2024 in the State Intellectual Property Office of China, the whole disclosure of which is incorporated herein by reference.

### FIELD OF THE INVENTION

The present invention relates to a connector housing assembly and a coaxial connector including the connector housing assembly.

### BACKGROUND

A rear cover of a high-definition vehicle-mounted camera is formed by cold forging of aluminum alloy. The rear cover of the camera is integrally formed with a housing of a connector. Due to the high requirements for a snap feature and dimensions of the housing of the connector, cold heading forming is difficult to achieve and requires secondary processing. In addition, when different snaps are provided on the housings of the vehicle-mounted connectors, it is necessary to redesign and manufacture molds, resulting in very high costs.

Moreover, in the prior art, sealing between an outer terminal of the connector and the rear cover of the camera is achieved by assembling a sealing ring. A thickness of the sealing ring generally needs to be 2 mm or more, the thickness increases due to the squeeze after the sealing ring is assembled in place, and therefore, the sealing ring requires at least 3 mm or more of space in a height direction of the connector. Currently, the development trend of vehicle-mounted high-definition cameras is high pixel count and small volume. Therefore, the sealing ring limits its application to a certain extent.

Moreover, in the prior art, it is necessary to provide a separate outer terminal for the connector, which leads to an excessive number of components of the connector, complicated assembly, and high costs.

The present invention has been made to overcome or alleviate at least one aspect of the above-mentioned disadvantages.

According to an aspect of the present invention, there is provided a connector housing assembly. The connector housing assembly includes: a rear cover and a housing. The rear cover includes an outer peripheral wall and a rear end wall that enclose an accommodating chamber. The housing includes: an outer cylinder; a flange portion formed on an outer side of a rear end portion of the outer cylinder; and an inner cylinder portion located in the outer cylinder and connected to an inner side of the outer cylinder. The housing is a one-piece metal part, the flange portion of the housing is fixed to an outer side of the rear end wall of the rear cover, and the inner cylinder portion of the housing serves as an outer terminal of a coaxial connector.

According to an exemplary embodiment of the present invention, a riveting portion for riveting the flange portion is formed on the outer side of the rear end wall, and the flange portion is riveted to the outer side of the rear end wall by means of the riveting portion.

According to another exemplary embodiment of the present invention, the riveting portion includes a plurality of riveting posts formed on the rear end wall of the rear cover, the plurality of riveting posts being spaced apart in a circumferential direction of the flange portion; and the plurality of through holes are formed in the flange portion, the plurality of riveting posts respectively pass through the plurality of through holes and ends of the riveting posts are curled and riveted onto peripheries of the through holes to fix the flange portion to the outer side of the rear end wall.

According to another exemplary embodiment of the present invention, the riveting portion includes a plurality of riveting tabs formed on the rear end wall of the rear cover, the plurality of riveting tabs being spaced apart in a circumferential direction of the flange portion and being curled and riveted onto a periphery of the flange portion to fix the flange portion to the outer side of the rear end wall.

According to another exemplary embodiment of the present invention, a recess adapted to fit with the flange portion of the housing is formed on the outer side of the rear end wall of the rear cover, and the flange portion of the housing is embedded in the recess of the rear end wall.

According to another exemplary embodiment of the present invention, a snap is formed on an outer side of the outer cylinder of the housing, and the snap is adapted to be snap-fitted into a snap groove in a mating housing of a first mating connector to lock the housing and the mating housing together.

According to another exemplary embodiment of the present invention, the outer cylinder of the housing has a guide rib extending in an axial direction thereof formed on an outer side thereof, the guide rib is configured to fit with a guide groove in a mating housing of a first mating connector to guide the insertion of the housing into the mating housing.

According to another exemplary embodiment of the present invention, the inner cylinder portion of the housing has a protruding rib extending in a circumferential direction thereof formed on an inner side thereof, the protruding rib being adapted to axially abut against a front end of an insulator inserted into the inner cylinder portion to axially position the insulator.

According to another exemplary embodiment of the present invention, the housing further includes a partition wall connected between a rear end of the inner cylinder portion and the inner side of the outer cylinder, the partition wall dividing an inner cavity of the outer cylinder into a front cavity and a rear cavity, and the inner cylinder portion being located in the front cavity of the outer cylinder.

According to another exemplary embodiment of the present invention, the rear cover is a one-piece stamped metal part or a one-piece die-cast metal part.

According to another exemplary embodiment of the present invention, a mounting hole is formed in the rear end wall, and a rear end of the outer cylinder is inserted into the mounting hole and protrudes from an inner side of the rear end wall; an annular rib surrounding the mounting hole is formed on the inner side of the rear end wall, and an annular injection groove is defined between the annular rib and the rear end of the outer cylinder, so as to achieve sealing between the rear end wall and the outer cylinder by means of a sealant injected into the annular injection groove.

According to another aspect of the present invention, there is provided a coaxial connector. The coaxial connector includes: the above connector housing assembly; an insulator inserted into the inner cylinder portion of the housing and formed with a central insertion hole; and a central terminal inserted into the central insertion hole of the insulator.

According to an exemplary embodiment of the present invention, the coaxial connector further includes: a first seal formed by a sealant poured into a rear cavity of the outer cylinder, the first seal is bonded to the outer cylinder, the insulator and the central terminal to achieve sealing between the outer cylinder and the insulator and between the insulator and the central terminal.

According to another exemplary embodiment of the present invention, the inner cylinder portion of the housing has a protruding rib extending in a circumferential direction thereof formed on an inner side thereof, the protruding rib axially abutting against a front end of the insulator to axially position the insulator.

According to another exemplary embodiment of the present invention, a protrusion is formed on the central terminal, and the protrusion is in interference fit with the insulator to fix the central terminal in the insulator.

According to another exemplary embodiment of the present invention, the inner cylinder portion is configured to mate with a first mating outer terminal of a first mating connector inserted into the outer cylinder, and the central terminal has a front end portion for mating with a first mating central terminal of the first mating connector inserted into a front end portion of the inner cylinder portion.

According to another exemplary embodiment of the present invention, the outer cylinder has a rear end portion for mating with a second mating outer terminal of a second mating connector inserted therein, and the central terminal has a rear end portion for mating with a second mating central terminal of the second mating connector inserted into the rear end portion of the outer cylinder.

According to another exemplary embodiment of the present invention, the coaxial connector further includes: a second seal formed by a sealant poured into an annular injection groove on an inner side of the rear end wall, the second seal is bonded between the rear end wall of the rear cover and a rear end of the outer cylinder to achieve sealing therebetween.

In the foregoing various exemplary embodiments according to the present invention, the housing of the connector and the rear cover are separately formed, thereby reducing the molding difficulty of the housing. Moreover, the inner cylinder portion of the housing of the present invention serves as the outer terminal of the coaxial connector, thereby it is not necessary to provide a separate outer terminal, such that reducing the number of components of the connector and reducing costs.

Moreover, in the foregoing various exemplary embodiments according to the present invention, sealing between the outer terminal of the connector and the rear cover is achieved by sealant pouring, thereby reducing the size of the connector.

### SUMMARY

A connector housing assembly includes a rear cover comprising an outer peripheral wall and a rear end wall that enclose an accommodating chamber. The connector housing assembly further includes a housing. The housing includes an outer cylinder, a flange portion formed on an outer side of a rear end portion of the outer cylinder, and an inner cylinder portion located in the outer cylinder and connected to an inner side of the outer cylinder, the housing is a one-piece metal part, the flange portion of the housing is fixed to an outer side of the rear end wall of the rear cover, and the inner cylinder portion of the housing serves as an outer terminal of a coaxial connector.

### BRIEF DESCRIPTION OF DRAWINGS

In the following, the present invention is described in more detail with references to the drawings in which:

FIG. 1 shows an illustrative perspective view of a coaxial connector according to an exemplary embodiment of the present invention;

FIG. 2 shows an axial cross-sectional view of the coaxial connector according to an exemplary embodiment of the present invention;

FIG. 3 shows an illustrative exploded view of the coaxial connector according to an exemplary embodiment of the present invention;

FIG. 4 shows an exploded cross-sectional view of the coaxial connector according to an exemplary embodiment of the present invention;

FIG. 5 shows another illustrative exploded view of the coaxial connector according to an exemplary embodiment of the present invention; and

FIG. 6 shows an axial cross-sectional view of the coaxial connector according to an exemplary embodiment of the present invention with a rear cover removed.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

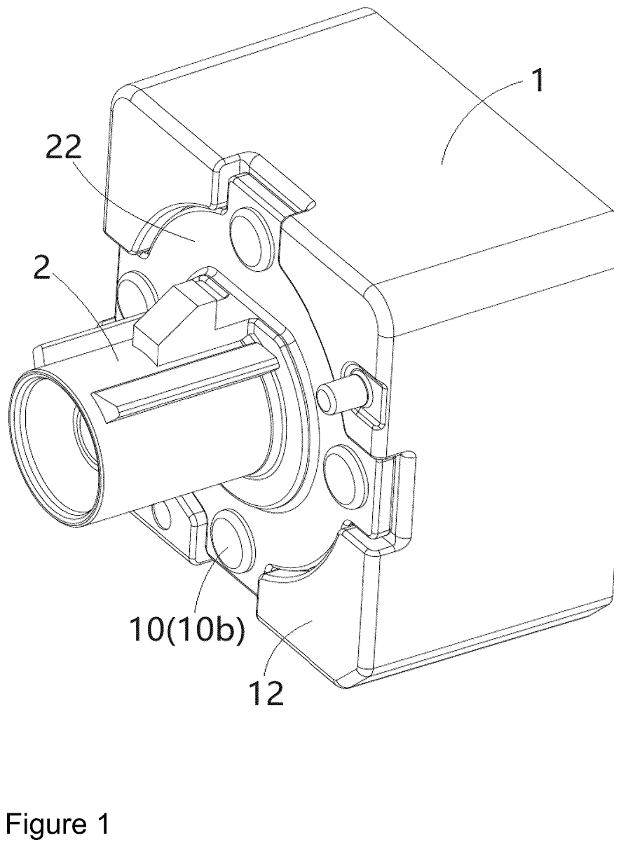

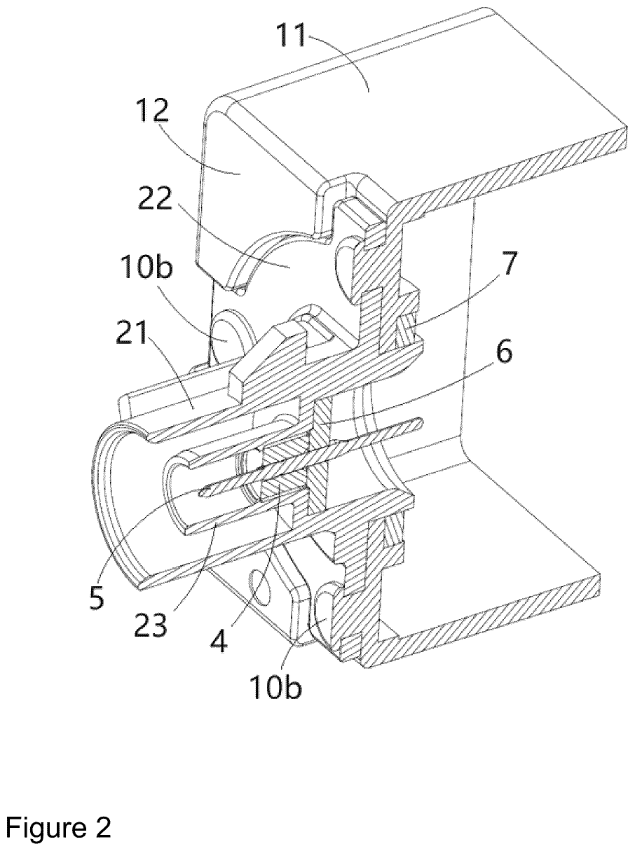

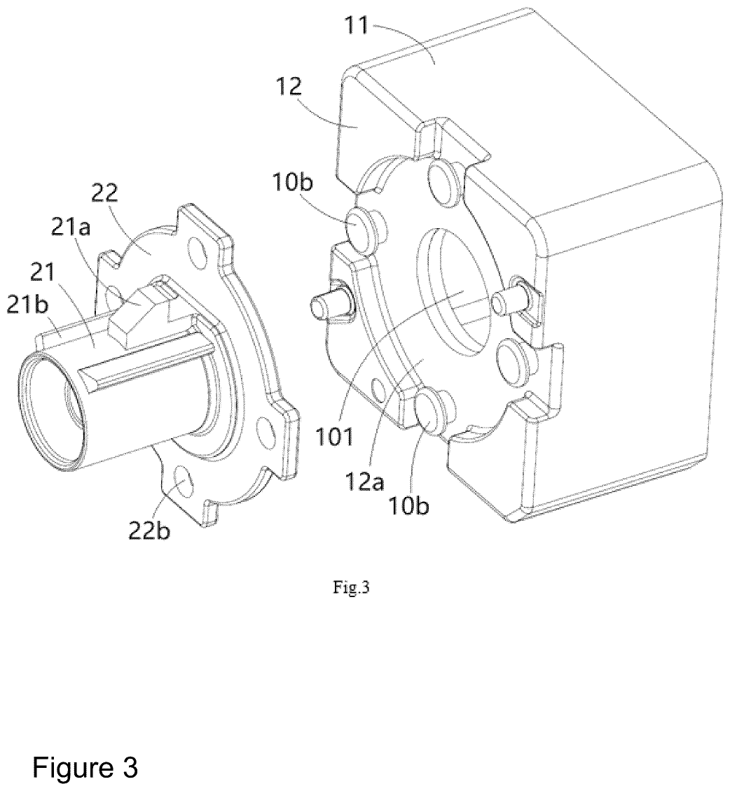

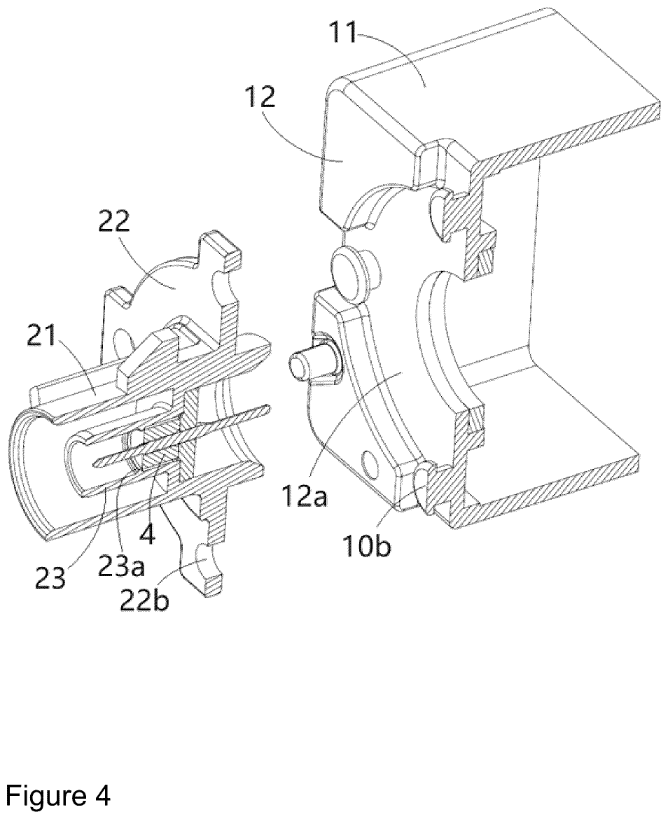

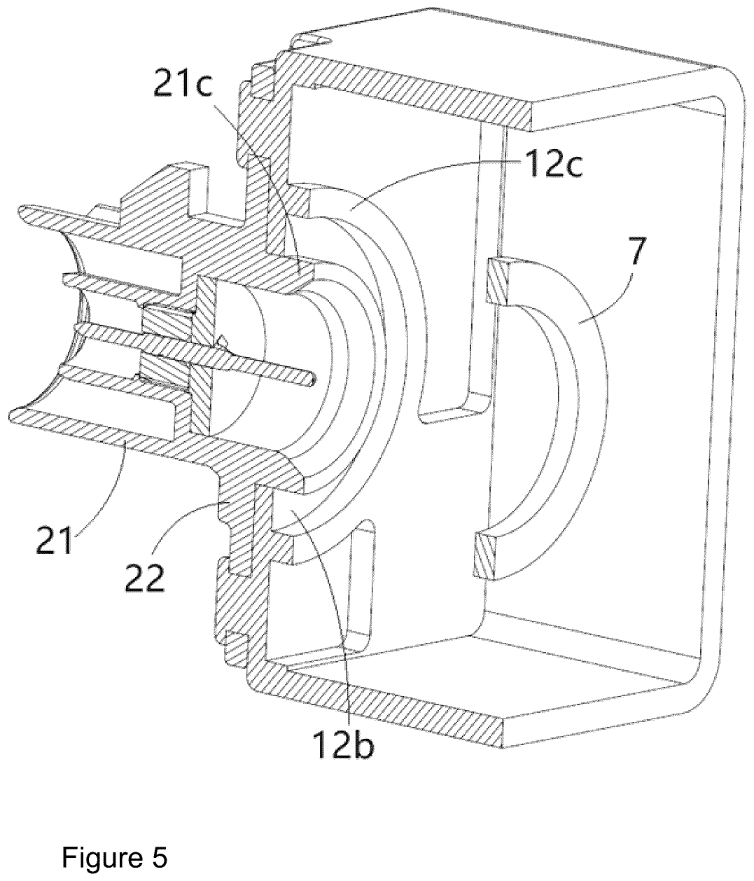

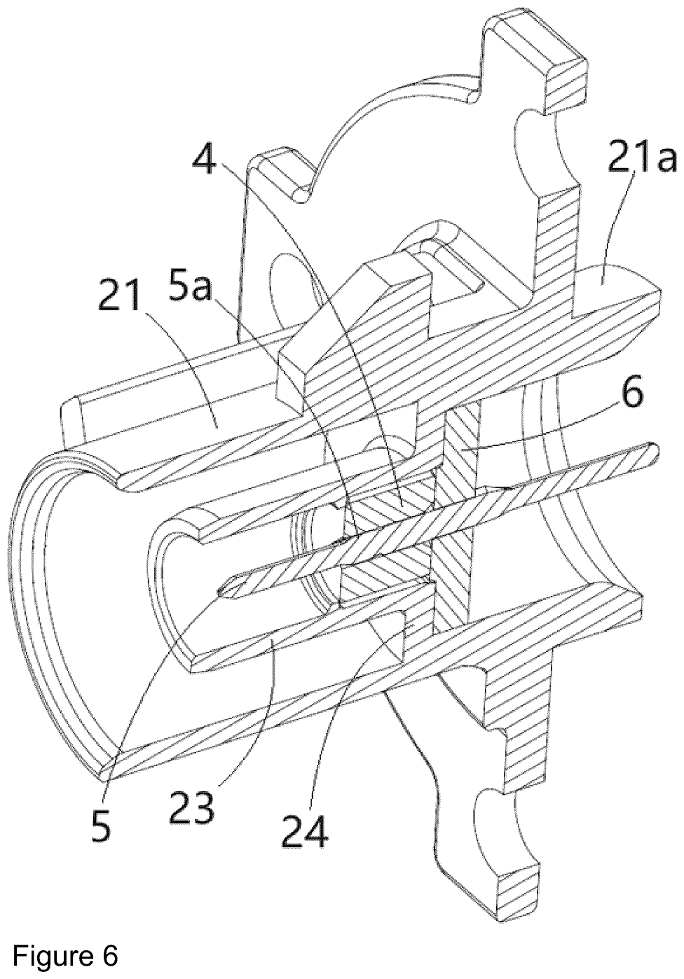

As shown in FIGS. 1 to 6, in an exemplary embodiment of the present invention, a connector housing assembly is disclosed. The connector housing assembly includes: a rear cover 1 and a housing 2. The rear cover 1 includes an outer peripheral wall 11 and a rear end wall 12 that enclose an accommodating chamber. The housing 2 includes an outer cylinder 21; a flange portion 22 and an inner cylinder portion 23. The flange portion 22 is formed on an outer side of a rear end portion of the outer cylinder 21. The inner cylinder portion 23 is located in the outer cylinder 21 and connected to an inner side of the outer cylinder 21. The housing 2 is a one-piece metal part, for example, the housing 2 may be a one-piece die-cast metal part, the flange portion 22 of the housing 2 is fixed to an outer side of the rear end wall 12 of the rear cover 1, and the inner cylinder portion 23 of the housing 2 serves as an outer terminal of a coaxial connector.

As shown in FIGS. 1 to 6, in the illustrated embodiment, a riveting portion 10 for riveting the flange portion 22 is formed on the outer side of the rear end wall 12, and the flange portion 22 is riveted to the outer side of the rear end wall 12 by means of the riveting portion 10.

As shown in FIGS. 1 to 6, in the illustrated embodiment, the riveting portion 10 includes a plurality of riveting posts 10b formed on the rear end wall 12 of the rear cover 1, the plurality of riveting posts 10b being spaced apart in a circumferential direction of the flange portion 22. A plurality of through holes 22b are formed in the flange portion 22, and the plurality of riveting posts 10b respectively pass through the plurality of through holes 22b, and ends of the riveting posts are curled and riveted onto peripheries of the through holes 22b to fix the flange portion 22 to the outer side of the rear end wall 12.

However, the present invention is not limited to the illustrated embodiment, for example, in another exemplary embodiment of the present invention, the riveting portion 10 includes a plurality of riveting tabs formed on the rear end wall 12 of the rear cover 1, the plurality of riveting tabs being spaced apart in a circumferential direction of the flange portion 22 and being curled and riveted onto a periphery of the flange portion 22 to fix the flange portion 22 to the outer side of the rear end wall 12.

As shown in FIGS. 1 to 6, in the illustrated embodiment, a recess 12a adapted to fit with the flange portion 22 of the housing 2 is formed on the outer side of the rear end wall 12 of the rear cover 1, and the flange portion 22 of the housing 2 is embedded in the recess 12a of the rear end wall 12.

As shown in FIGS. 1 to 6, in the illustrated embodiment, a snap 21a is formed on an outer side of the outer cylinder 21 of the housing 2, and the snap 21a is adapted to be snap-fitted into a snap groove in a mating housing of a first mating connector to lock the housing 2 and the mating housing together.

As shown in FIGS. 1 to 6, in the illustrated embodiment, the outer cylinder 21 of the housing 2 has a guide rib 21b extending in an axial direction thereof formed on an outer side thereof, the guide rib 21b is configured to fit with a guide groove in a mating housing of a first mating connector to guide the insertion of the housing 2 into the mating housing.

As shown in FIGS. 1 to 6, in the illustrated embodiment, the inner cylinder portion 23 of the housing 2 has a protruding rib 23a extending in a circumferential direction thereof formed on an inner side thereof, the protruding rib 23a being adapted to axially abut against a front end of an insulator 4 inserted into the inner cylinder portion 23 to axially position the insulator 4.

As shown in FIGS. 1 to 6, in the illustrated embodiment, the housing 2 further includes a partition wall 24 connected between a rear end of the inner cylinder portion 23 and the inner side of the outer cylinder 21, the partition wall 24 dividing an inner cavity of the outer cylinder 21 into a front cavity and a rear cavity, and the inner cylinder portion 23 being located in the front cavity of the outer cylinder 21.

As shown in FIGS. 1 to 6, in the illustrated embodiment, the rear cover 1 may be a one-piece stamped metal part or a one-piece die-cast metal part.

As shown in FIGS. 1 to 6, in the illustrated embodiment, a mounting hole 101 is formed in the rear end wall 12, and a rear end 21c of the outer cylinder 21 is inserted into the mounting hole 101 and protrudes from an inner side of the rear end wall 12. An annular rib 12c surrounding the mounting hole 101 is formed on the inner side of the rear end wall 12, and an annular injection groove 12b is defined between the annular rib 12c and the rear end 21c of the outer cylinder 21, so as to achieve sealing between the rear end wall 12 and the outer cylinder 21 by means of a sealant injected into the annular injection groove 12b.

As shown in FIGS. 1 to 6, in another exemplary embodiment of the present invention, a coaxial connector is also disclosed. The coaxial connector includes: the above connector housing assembly, an insulator 4 and a central terminal 5. The insulator 4 is inserted into the inner cylinder portion 23 of the housing 2 and formed with a central insertion hole. The central terminal 5 is inserted into the central insertion hole of the insulator 4.

As shown in FIGS. 1 to 6, in the illustrated embodiment, the coaxial connector further includes a first seal 6 formed by a sealant poured into a rear cavity of the outer cylinder 21. The first seal 6 is bonded to the outer cylinder 21, the insulator 4 and the central terminal 5 to achieve sealing between the outer cylinder 21 and the insulator 4 and between the insulator 4 and the central terminal 5.

As shown in FIGS. 1 to 6, in the illustrated embodiment, the inner cylinder portion 23 of the housing 2 has a protruding rib 23a extending in a circumferential direction thereof formed on an inner side thereof, the protruding rib 23a axially abutting against a front end of the insulator 4 to axially position the insulator 4.

As shown in FIGS. 1 to 6, in the illustrated embodiment, a protrusion 5a is formed on the central terminal 5, and the protrusion 5a is in interference fit with the insulator 4 to fix the central terminal 5 in the insulator 4.

As shown in FIGS. 1 to 6, in the illustrated embodiment, the inner cylinder portion 23 is configured to mate with a first mating outer terminal of a first mating connector inserted into the outer cylinder 21, and the central terminal 5 has a front end portion for mating with a first mating central terminal of the first mating connector inserted into a front end portion of the inner cylinder portion 23.

As shown in FIGS. 1 to 6, in the illustrated embodiment, the outer cylinder 21 has a rear end portion for mating with a second mating outer terminal of a second mating connector inserted therein, and the central terminal 5 has a rear end portion for mating with a second mating central terminal of the second mating connector inserted into the rear end portion of the outer cylinder 21.

As shown in FIGS. 1 to 6, in the illustrated embodiment, the above coaxial connector further includes a second seal 7 formed by a sealant poured into an annular injection groove 12b on an inner side of the rear end wall 12. The second seal 7 is bonded between the rear end wall 12 of the rear cover 1 and a rear end 21c of the outer cylinder 21 to achieve sealing therebetween.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property.

What is claimed is:

1. A connector housing assembly, comprising:
a rear cover comprising an outer peripheral wall and a rear end wall that enclose an accommodating chamber;
a housing comprising:
an outer cylinder;
a flange portion formed on an outer side of a rear end portion of the outer cylinder; and
an inner cylinder portion located in the outer cylinder and connected to an inner side of the outer cylinder, the housing is a one-piece metal part, the flange portion of the housing is fixed to an outer side of the rear end wall of the rear cover, and the inner cylinder portion of the housing serves as an outer terminal of a coaxial connector.

2. The connector housing assembly of claim 1, wherein a riveting portion is formed on the outer side of the rear end wall, and the flange portion is riveted to the outer side of the rear end wall by the riveting portion.

3. The connector housing assembly of claim 2, wherein the riveting portion comprises a plurality of riveting posts formed on the rear end wall of the rear cover, the plurality of riveting posts being spaced apart in a circumferential direction of the flange portion.

4. The connector housing assembly of claim 3, wherein a plurality of through holes are formed in the flange portion, and the plurality of riveting posts, respectively pass through the plurality of through holes and ends of the plurality of riveting posts are curled and riveted onto peripheries of the plurality of through holes, to fix the flange portion to the outer side of the rear end wall.

5. The connector housing assembly of claim 2, wherein the riveting portion comprises a plurality of riveting tabs formed on the rear end wall of the rear cover, the plurality of riveting tabs being spaced apart in a circumferential direction of the flange portion and being curled and riveted onto a periphery of the flange portion to fix the flange portion to the outer side of the rear end wall.

6. The connector housing assembly of claim 1, wherein a recess adapted to fit with the flange portion of the housing is formed on the outer side of the rear end wall of the rear cover, and the flange portion of the housing is embedded in the recess of the rear end wall.

7. The connector housing assembly of claim 1, wherein a snap is formed on an outer side of the outer cylinder of the housing, and the snap is adapted to be snap-fitted into a snap groove in a mating housing of a first mating connector to lock the housing and the mating housing together.

8. The connector housing assembly of claim 1, wherein the outer cylinder of the housing has a guide rib extending in an axial direction thereof formed on an outer side thereof, the guide rib is configured to fit with a guide groove in a mating housing of a first mating connector to guide an insertion of the housing into the mating housing.

9. The connector housing assembly of claim 1, wherein the inner cylinder portion of the housing has a protruding rib extending in a circumferential direction thereof formed on an inner side thereof, the protruding rib being adapted to axially abut against a front end of an insulator inserted into the inner cylinder portion to axially position the insulator.

10. The connector housing assembly of claim 1, wherein the housing further comprises a partition wall connected between a rear end of the inner cylinder portion and the inner side of the outer cylinder, the partition wall dividing an inner cavity of the outer cylinder into a front cavity and a rear cavity, and the inner cylinder portion being located in the front cavity of the outer cylinder.

11. The connector housing assembly of claim 1, wherein the rear cover is a one-piece stamped metal part or a one-piece die-cast metal part.

12. The connector housing assembly of claim 1, wherein a mounting hole is formed in the rear end wall, and a rear end of the outer cylinder is inserted into the mounting hole and protrudes from an inner side of the rear end wall; and wherein an annular rib surrounding the mounting hole is formed on the inner side of the rear end wall, and an annular injection groove is defined between the annular rib and the rear end of the outer cylinder, so as to achieve sealing between the rear end wall and the outer cylinder by means of a sealant injected into the annular injection groove.

13. A coaxial connector, comprising:
a connector housing assembly;
an insulator inserted into an inner cylinder portion of the connector housing assembly and formed with a central insertion hole; and
a central terminal inserted into the central insertion hole of the insulator.

14. The coaxial connector of claim 13, further includes a first seal formed by a sealant poured into a rear cavity of an outer cylinder, the first seal is bonded to the outer cylinder, the insulator and the central terminal sealing between the outer cylinder and the insulator and between the insulator and the central terminal.

15. The coaxial connector of claim 13, wherein the inner cylinder portion of the connector housing assembly has a protruding rib extending in a circumferential direction thereof formed on an inner side thereof, the protruding rib axially abutting against a front end of the insulator to axially position the insulator.

16. The coaxial connector of claim 13, wherein a protrusion is formed on the central terminal, and the protrusion is in interference fit with the insulator.

17. The coaxial connector of claim 13, wherein the inner cylinder portion is configured to mate with a first mating outer terminal of a first mating connector inserted into an outer cylinder, and the central terminal has a front end portion for mating with a first mating central terminal of the first mating connector inserted into a front end portion of the inner cylinder portion.

18. The coaxial connector of claim 13, wherein an outer cylinder has a rear end portion for mating with a second mating outer terminal of a second mating connector inserted therein, and the central terminal has a rear end portion for mating with a second mating central terminal of the second mating connector inserted into the rear end portion of the outer cylinder.

19. The coaxial connector of claim 13, further includes a second seal formed by a sealant poured into an annular injection groove on an inner side of a rear end wall.

20. The coaxial connector of claim 19, wherein the second seal is bonded between the rear end wall of a rear cover and a rear end of an outer cylinder to achieve sealing therebetween.
